(19) United States
(12) Patent Application Publication
(10) Pub. No.: US 2016/0212295 A1
(43) Pub. Date: Jul. 21, 2016

(54) DRIVE CONTROL APPARATUS, CONVEYING APPARATUS, IMAGE FORMING APPARATUS AND DRIVE CONTROL METHOD

(71) Applicants: Takuya MURATA, Tokyo (JP); Tomoki SHIMOHIRA, Kanagawa (JP); Haipeng ZHANG, Tokyo (JP)

(72) Inventors: Takuya MURATA, Tokyo (JP); Tomoki SHIMOHIRA, Kanagawa (JP); Haipeng ZHANG, Tokyo (JP)

(73) Assignee: Ricoh Company, Ltd., Ohta-ku (JP)

(21) Appl. No.: 15/000,696

(22) Filed: Jan. 19, 2016

(30) Foreign Application Priority Data
Jan. 21, 2015 (JP) 2015-009276

(51) Int. Cl. H04N 1/06; G03G 15/00; H04N 1/00

(52) U.S. Cl. CPC H04N 1/06; H04N 1/0032; H04N 1/0057; G03G 15/55

(57) ABSTRACT

A drive control apparatus includes a controller which controls a drive unit based on a voltage instruction signal obtained from a target signal and an abnormality detection unit which obtains the voltage instruction signal M times in a detection time period. The abnormality detection unit detects occurrence of an abnormality in response to detecting that the voltage instruction signal is outside predetermined range N times in the detection time period, where M is equal to or more than 2 and N is equal to or more than 1 and N is less than M.

### BACKGROUND OF THE INVENTION

1. Field of the Invention

The disclosures herein generally relate to a drive control apparatus, a conveying apparatus, an image forming apparatus, and a drive control method.

2. Description of the Related Art

An electrophotographic image forming apparatus which includes various motors such as transfer motor, a fixing motor, and a conveying motor is known in the art. The transfer motor rotates a transfer roller which transfers toner images on a paper. The fixing motor rotates a fixed roller which fixes the toner images on the paper. The conveying motor rotates a conveying roller which conveys the paper.

Japanese Unexamined Patent Application Publication No. 2013-162684 discloses a technique which detects an abnormality of a motor or a load such as the conveying roller which is connected to the motor, in a case in which a control amount of the motor continues exceeding a predetermined value in a time period equal to or longer than a predetermined time period.

However, even if the abnormality occurs in the motor or the load and the control amount becomes equal to or larger than the predetermined value, the technique of the Japanese Unexamined Patent Application Publication No. 2013-162684 cannot detect the abnormality in a case in which the control amount falls below the predetermined value momentarily due to a fluctuation of the load, a noise or the like before the predetermined time period elapses. Thus, there is a possibility that the technique of the Japanese Unexamined Patent Application Publication No. 2013-162684 dose not detect the abnormality of the motor or the load which actually occurs and a failure of the motor, the load, or other parts cannot be prevented.

### SUMMARY OF THE INVENTION

It is a general object of at least one embodiment of the present invention to provide a drive control apparatus, a conveying apparatus, an image forming apparatus, and a drive control method that substantially obviates one or more problems caused by the limitations and disadvantages of the related art.

In one embodiment, a drive control apparatus includes a controller configured to control a drive unit based on a voltage instruction signal obtained from a target signal and an abnormality detection unit configured to obtain the voltage instruction signal M times in a detection time period, the abnormality detection unit detecting occurrence of an abnormality in response to detecting that the voltage instruction signal is outside of a predetermined range N times in the detection time period, where M is equal to or more than 2 and N is equal to or more than 1 and N is less than M.

An embodiment of the present invention also provides a drive control method which includes a step of controlling a drive unit based on a voltage instruction signal obtained from a target signal and a step of obtaining the voltage instruction signal M times in a detection time period and detecting occurrence of an abnormality in response to detecting that the voltage instruction signal is outside of a predetermined range N times in the detection time period, where M is equal to or more than 2 and N is equal to or more than 1 and N is less than M.

### BRIEF DESCRIPTION OF THE DRAWINGS

FIG. 1 is a drawing exemplarily illustrating a schematic configuration of an image forming apparatus according to a first embodiment;

FIG. 2 is a drawing exemplarily illustrating a configuration of a drive control apparatus according to the first embodiment;

FIG. 3 is a drawing exemplarily illustrating a configuration of a position and speed following controller according to the first embodiment;

FIG. 4 is a drawing exemplarily illustrating the configuration of the drive control apparatus according to a variation of the first embodiment;

FIG. 5 is a drawing exemplarily illustrating a configuration of a speed following controller according to the variation of the first embodiment;

FIG. 6 is a flowchart for exemplarily illustrating a flow of an abnormality detection process according to the first embodiment;

FIG. 7 is a graph for describing the abnormality detection process according to the first embodiment;

FIG. 8 is a flowchart for exemplarily illustrating a flow of an abnormality detection process according to a second embodiment;

FIG. 9 a flowchart for exemplarily illustrating a flow of an abnormality detection process according to a third embodiment;

FIG. 10 is a graph for describing the abnormality detection process according to the third embodiment;

FIG. 11 is a flowchart for exemplarily illustrating a flow of an abnormality detection process according to a fourth embodiment; and

FIG. 12 is a flowchart for exemplarily illustrating a flow of an abnormality detection process according to a fifth embodiment.

### DESCRIPTION OF THE PREFERRED EMBODIMENTS

In the following, embodiments of the present invention will be described, with reference to the accompanying drawings. In the following drawings, n same reference numbers are used for the same structures and an overlapping description may be omitted as appropriate.

<Configuration of an Image Forming Apparatus>

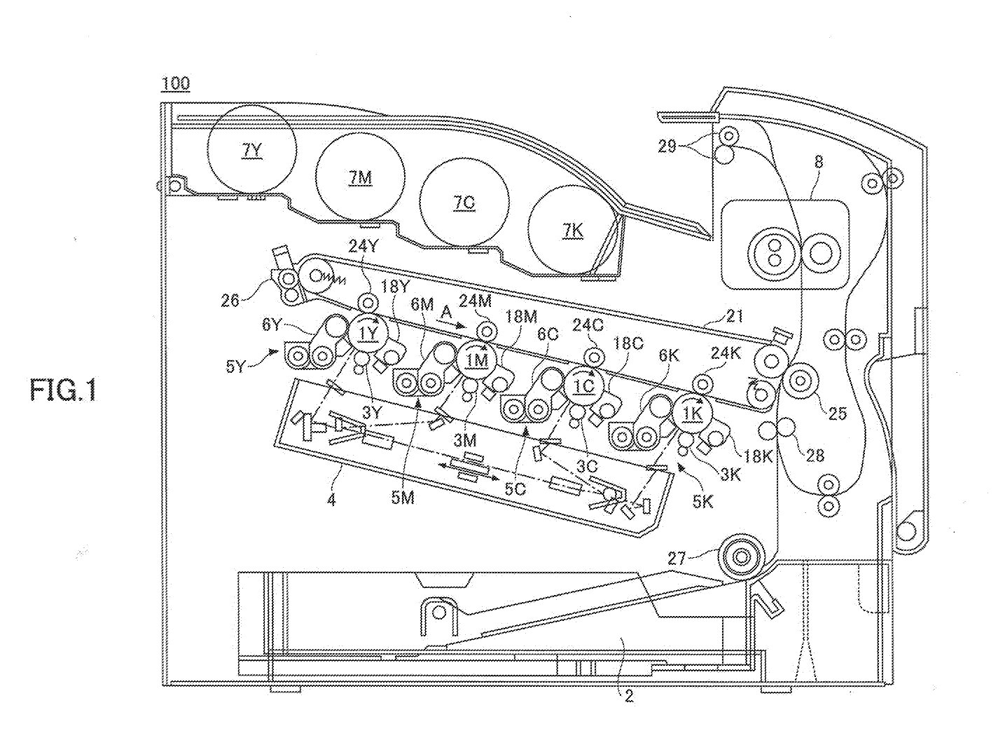

FIG. 1 is a diagram exemplarily illustrating a schematic configuration of an image forming apparatus 100 according to a first embodiment. The image forming apparatus 100 is an electrophotographic full color printer. The image forming apparatus 100 forms a full colors image on a recording medium by using four color (yellow (Y), magenta (M), cyan (C), and black (K)) of toner.

When image data is input in the image forming apparatus 100, surfaces of photoconductor drums 1Y, 1M, 1C, and 1K (in the following, “Y, M, C, and K” are appropriately omitted), which are rotating, of developing units 5 are charged by charging devices 3. An exposure device 4 emits laser light corresponding to the image data and forms electrostatic latent images on the surfaces of the photoconductor drums 1.

Developing devices 6 impart toners on the electrostatic latent images formed on the photoconductor drums 1 to form toner images. The toner images formed on the respective photoconductor drums 1 of the developing units 5 are superposed and transferred on a surface of an intermediate transfer belt 21 which is rotated by primary transfer rollers 24. Thus a full color toner image is formed on the surface of the intermediate transfer belt 21.

On the other hand, a feeding roller 27 feeds a paper as the recording medium to a conveyance path from a feeding cassette 2. The paper is conveyed by a conveying roller 28 along the conveyance path. The full color toner image on the intermediate transfer belt 21 is transferred on the paper when the paper passes between the intermediate transfer belt 21 and a secondary transfer roller 25.

The paper, on which the full color toner image is formed, is conveyed to a fixing device 8. The paper is heated and pressed between a heating roller and a pressing roller, and the full color toner image is fixed on the paper. The paper is ejected outside of the apparatus by a paper ejecting roller 29 in a state that the full color toner image is fixed on the paper.

After the toner images are transferred, the residual toners on the surfaces of the photoconductor drums 1 are removed by cleaning devices of the developing units 5. Further, the residual toners on the intermediate transfer belt 21 are removed by an intermediate transfer belt cleaning devices 26.

A predetermined amount of toner is supplied to each of the developing devices 6 from toner bottles 7y, 7M, 7C, and 7K via a transport path not shown. The toner bottles 7 are filled with respective four colors of toners. The developing devices 6 consume toners when forming the images.

In the image forming apparatus 100, each of loads such as a developing roller of the developing units 5, a driving roller which drives and rotates the intermediate transfer belt the primary transfer rollers 24, the secondary transfer roller 25, the heating roller and the pressing roller of the fixing unit 8, the conveying roller 28, and the paper electing roller 29 is connected to a motor as a drive unit. These loads are configured to rotate in a set speed.

<Configuration of a Drive Control Apparatus>

In the following, a configuration of a drive control apparatus which controls a motor provided on the image forming apparatus 100 according to the first embodiment will be described. The drive control apparatus controls driving of the motor and detects an abnormality of the motor or the load, which is connected to the motor, such as the conveying roller 28 (referred to as “the load” hereinafter).

[Drive Control of the Motor]

First, the configuration of the drive control apparatus which controls the driving of the motor is described.

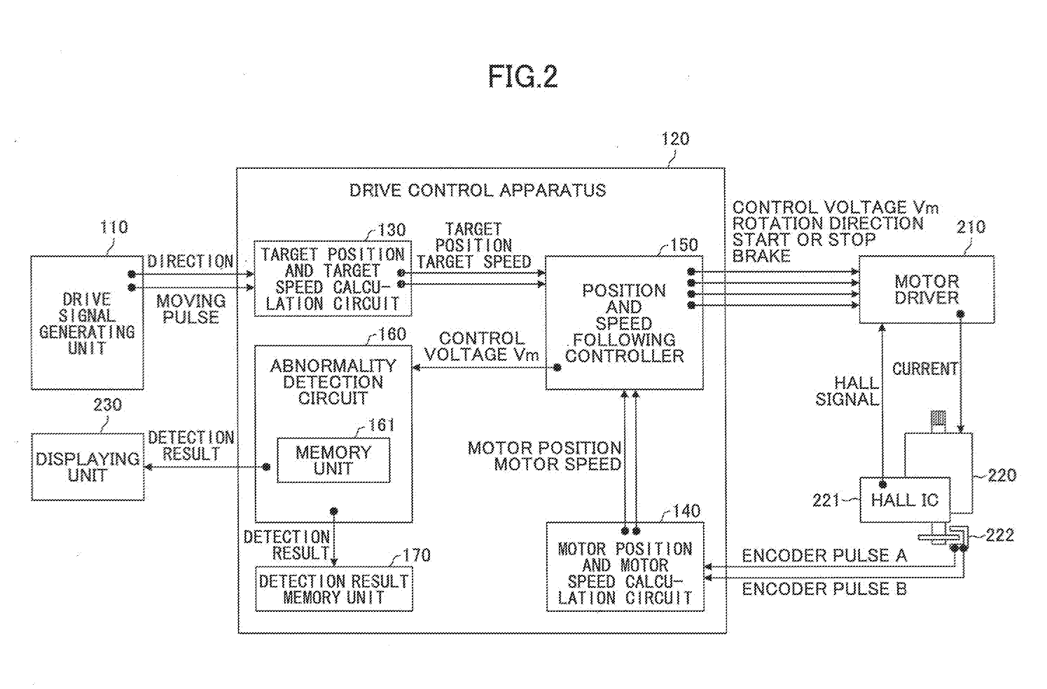

FIG. 2 is a drawing exemplarily illustrating the configuration of the drive control apparatus 120 according to the first embodiment. FIG. 2 shows the example configuration of the drive control apparatus 120 which executes feedback control of a position and a rotational speed of a motor 220, which rotates the load disposed on the image forming apparatus 100 such as the conveying roller 28.

As shown in FIG. 2, the drive control apparatus 120 includes a target position and target speed calculation circuit 130, a motor position and motor speed calculation circuit 140, and a position and speed following controller 150. For example, the drive control apparatus 120 may be an integrated circuit such as an application specific integrated circuit (ASIC) or a field programmable gate array (FPGA). However, the present invention is not limited to this. The drive control apparatus 120 may be a circuit which may achieve functions of the drive control apparatus 120 described below.

The target position and target speed calculation circuit 130 receives a drive signal such as a rotation direction signal and a moving pulse number from a drive signal generating unit 110 which is disposed on the image forming apparatus 100. The target position and target speed calculation circuit 130 calculates a target position and a target speed of the motor 220 from the received information and time information attained from an oscillator (not shown). The target position and target speed calculation circuit 130 transmits the calculated target position and the calculated target speed to the position and speed following controller 150 as a target signal.

The motor position and motor speed calculation circuit 140 obtains two-phase encoder pulses A and B from an encoder sensor 222 disposed on the motor 220. The motor position and motor speed calculation circuit 140 calculates a current position and a current speed of the motor 220 from the encoder pulses A and B and the time information of the oscillator (not shown). The motor position and motor speed calculation circuit 140 transmits the calculated current position and the calculated current speed of the motor 220 to the position and speed following controller 150.

The position and speed following controller 150 transmits a control voltage Vm to a motor driver 210 as a voltage instruction signal. The control voltage Vm is calculated from the target signal, which includes the target position and the target speed, and the current position and the current speed of the motor 220 such that each of the position and the speed of the motor 220 matches the target. In other words, the voltage instruction signal is obtained from the target signal.

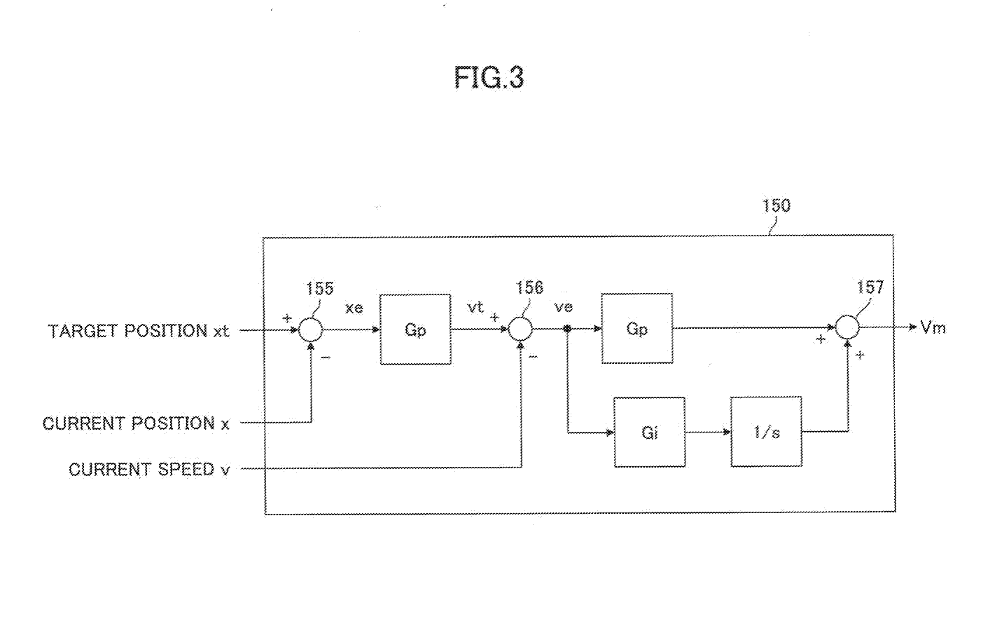

FIG. 3 is a drawing exemplarily illustrating a configuration of the position and speed following controller 150 according to the first embodiment. FIG. 3 shows the example configuration of the position and speed following controller 150 which controls the position and speed the motor 220 based on a combination of proportional control and integral control.

A target position xt and a target speed vt are input in the position and speed following controller 150 from the target position and target speed calculation circuit 130. A current position x and a current speed v of the motor 220 are input in the position and speed following controller 150 from the motor position and motor speed calculation circuit 140.

A subtractor 155 calculates a difference between the target position xt and the current position x, and outputs a position deviation signal xe. The position deviation signal xe calculated by the subtractor 155 is multiplied by a proportional gain Gp, and output to a subtractor 156 as the target speed vt.

The subtractor 156 calculates a difference between the target speed vt and the current speed v, and outputs a speed deviation signal ve. A proportional calculated value multiplied by the proportional gain Gp and an integral calculated value multiplied by the integrated gain Gi are calculated from the speed deviation signal ve which is output from the subtractor 156. An adder 157 adds the proportional calculated value and the integral calculated value, which are calculated, and converts the result into the control voltage Vm. The adder 157 outputs the control voltage Vm.

According to the above described configuration, the position and speed following controller 150 outputs the control signal Vm calculated from the target position and the target speed of the motor 220, and controls the motor 220 such that each of the position and the speed of the motor 220 matches the target position and the target speed respectively.

The position and speed following controller 150 may transmit a duty ratio of a PWM signal or the like to the motor driver 210 as the voltage instruction signal. Further, the position and speed following controller 150 transmits control signals which include the voltage instruction signal, the rotation direction signal, start or stop signals, and a brake signal to the motor driver 210.

The motor driver 210 controls a current flowing through the motor 220, the rotation direction and the like based on the control signal transmitted from the position and speed following controller 150 and a Hall signal transmitted from a Hall IC 221.

For example, the motor 220 may be a DC motor. The motor 220 may be connected to the load such as the conveying roller 28 disposed on the image forming apparatus 100 via a transmission mechanism which includes a plurality of gears. The motor 220 is controlled by the position and speed following controller 150 in order to rotate the load at a predetermined speed. The motor 220 is controlled by the position and speed following controller 150 in order to rotate at the target position and the target speed.

The load connected to the motor 220 may be the developing roller, the transfer rollers 24, the secondary transfer roller 25, the heating roller, the pressing roller, the conveying roller 28, the paper ejecting roller 29 or the like. Further, the load may be other configuration elements which are disposed on the image forming apparatus 100.

Although the above described embodiment is a configuration which controls the position and the speed of the motor 220, the drive control apparatus 120 may be a configuration which controls at least one of the position, the speed, and the torque of the motor 220.

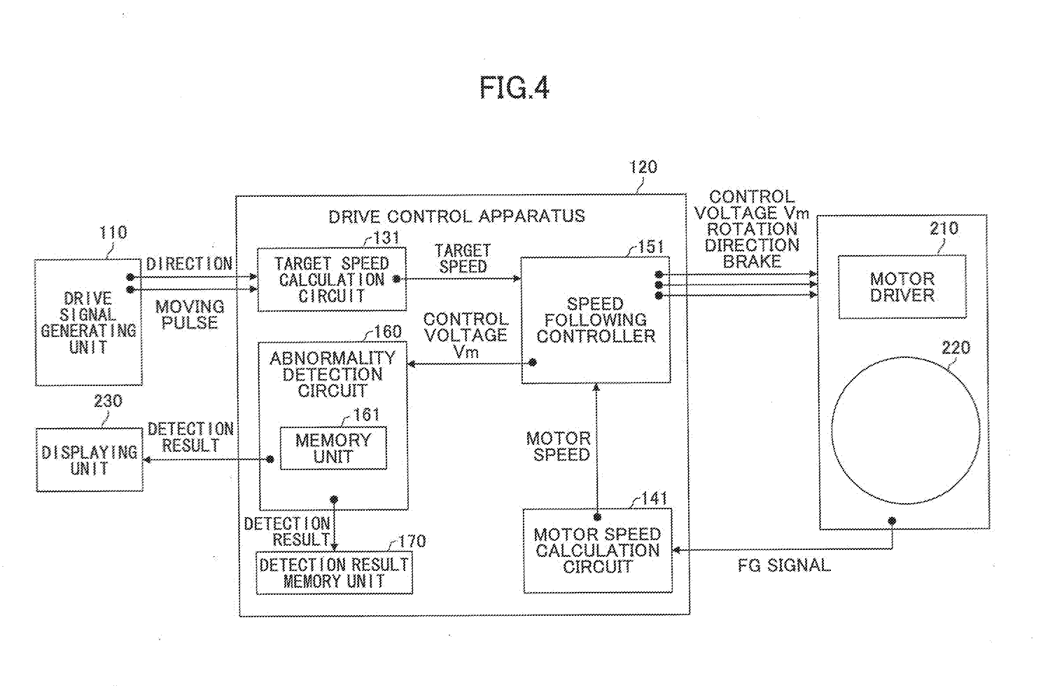

FIG. 4 is a drawing exemplarily illustrating a variation of the configuration of the drive control apparatus 120 which controls the speed of the motor 220.

The drive control apparatus 120 exemplarily shown in FIG. 4 includes a target speed calculation circuit 131, a motor speed calculation circuit 141, and a speed following controller 151. The motor driver 210 is mounted on the motor 220 exemplarily shown in FIG. 4. The motor 220 outputs a speed detection signal (FG signal) whose frequency is proportional to a rotation number (the rotational speed) of a rotor.

The target speed calculation circuit 131 receives a drive signal such as a rotation direction signal and a moving pulse number from the drive signal generating unit 110 which is disposed on the image forming apparatus 100. The target speed calculation circuit 131 calculates a target speed of the motor 220 from the received information and time information obtained from the oscillator (not shown). The target speed calculation circuit 131 transmits the calculated target speed to the speed following controller 151 as a target signal.

The motor speed calculation circuit 141 calculates a current speed of the motor 220 from the FG signal obtained from the motor 220 and the time information of the oscillator (not shown). The motor speed calculation circuit 141 transmits the calculated current speed of the motor 220 to the speed following controller 151.

The speed following controller 151 transmits a control voltage Vm to the motor driver 210 as a control signal. The control voltage Vm is calculated from the target signal, which includes the target speed, such that the motor speed approaches the target.

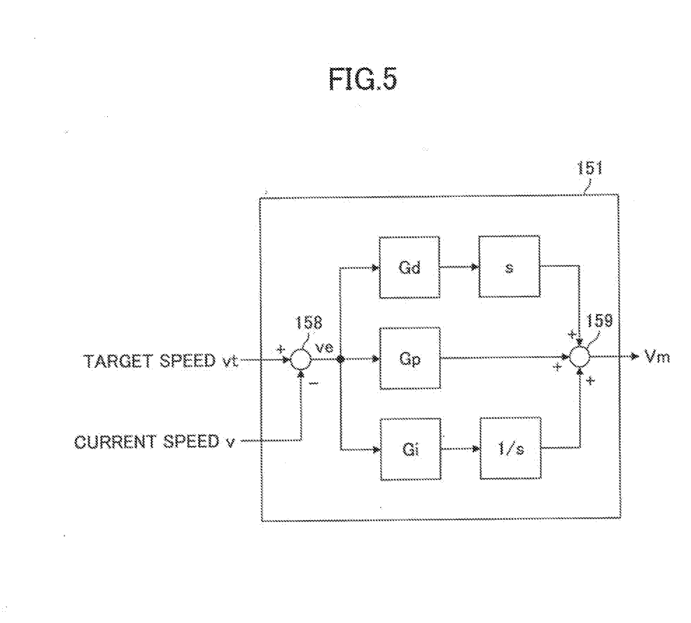

FIG. 5 is a drawing exemplarily illustrating the variation of configuration of the speed following controller 151 according to the first embodiment.

A target speed vt is input in the speed following controller 151 from the target speed calculation circuit 131. A current speed v is input in the speed following controller 151 from the motor speed calculation circuit 141.

The subtractor 158 calculates a difference between the target speed vt and the current speed v which are input, and outputs a speed deviation signal ve. A proportional calculated value multiplied by the proportional gain Gp, an integral calculated value multiplied by the integrated gain Gi, and a differential calculated value multiplied by the proportional gain Gd are calculated from the speed deviation signal ve which is output from the subtractor 158.

An adder 159 adds the proportional calculated value, the integral calculated value, and the differential calculated value, which are calculated, and converts the result into the control voltage Vm. The adder 159 outputs the control voltage Vm.

According to the above described configuration, the speed following controller 151 outputs the control signal Vm calculated from the target speed of the motor 220 to the motor driver 210, and controls the motor 220 such that the speed of the motor 220 matches the target speed.

As described above, the drive control apparatus 120 may have a configuration which controls the position and the speed or a configuration which controls the speed. Further, the drive control apparatus 120 may have a configuration which controls the position of the motor 220 or a configuration which controls the torque. In a case in which the torque is controlled, a target torque is input in a torque following controller disposed on the drive control apparatus 120. The torque following controller outputs the control voltage Vm based on the target torque.

The controller disposed on the drive control apparatus 120 may control the motor 220 based on at least one of the proportional control, the differential control, and the integral control. As described above, the drive control apparatus 120 controls at least one of the position, the speed, and the torque of the motor 220 in order to drive the load, which is connected to the motor 220, in accordance with conditions set for the image forming apparatus 100.

[Abnormality Detection of the Motor or the Load]

In the following, a configuration of the drive control apparatus 120 which detects an abnormality of the motor or the load is described.

As shown in FIG. 2 or FIG. 4, the drive control apparatus 120 according to the first embodiment includes an abnormality detection circuit 160 and a detection result memory unit 170.

The abnormality detection circuit 160 obtains the control voltage Vm from the position and speed following controller 150. The abnormality detection circuit 160 detects the abnormality of the load or the motor 220 based on the obtained control voltage Vm. The abnormality detection circuit 160 includes a memory unit 161 which stores the obtained control voltage Vm and the like.

The detection result memory unit 170 stores the detection result of the abnormality detection circuit 160. For example, analysis such as fault prediction of the motor 220 and the load may be performed based on the detection result stored in the detection result memory unit 170.

A displaying unit 230 may be, for example, a liquid crystal display. The displaying unit 230 notifies a user of occurrence of the abnormality in the image forming apparatus 100 in a case in which the abnormality detection circuit 160 detects the abnormality of the motor 220 or the load. The user may respond to the notification and check (determine) a cause of the occurrence of the abnormality. Thus, the failure of the motor 220 or the load may be prevented.

(Abnormality Detection Process)

In the following, abnormality detection processes of embodiments executed in the abnormality detection circuit 160 are described.

### First Embodiment

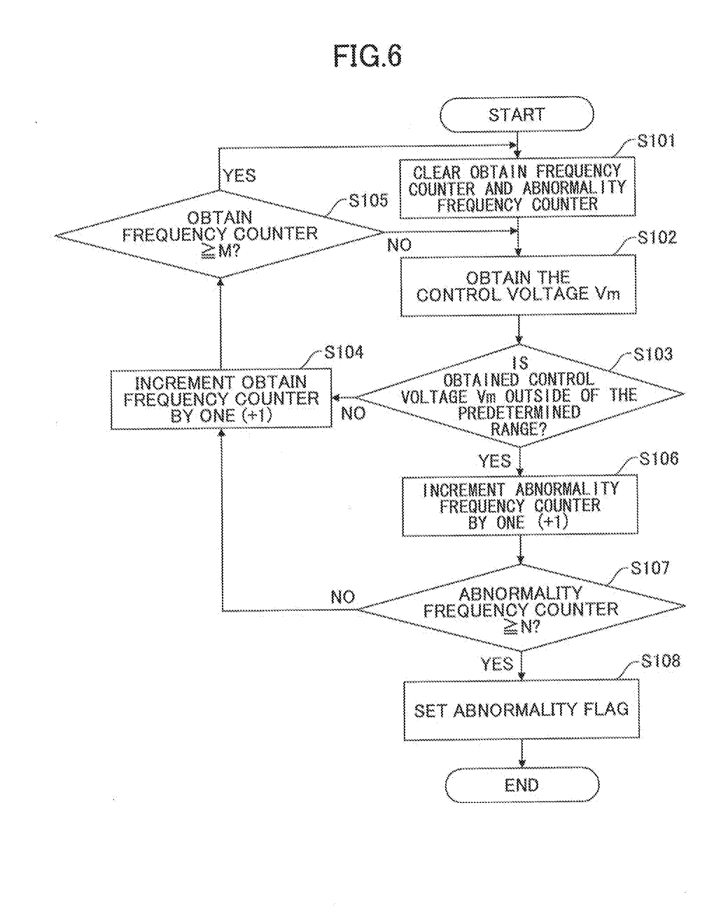

FIG. 6 a flowchart for exemplarily illustrating a flow of the abnormality detection process of the first embodiment. The drive control apparatus 120 drives the motor 220 based on the drive signal from the drive signal generating unit 110 and executes the abnormality detection process.

In step S101 of the abnormality detection process according to the first embodiment, the abnormality detection circuit 160 clears an obtain frequency counter and an abnormality frequency counter. The obtain frequency counter is a value which indicates the number of times (the frequency) for which the control voltage Vm is obtained by the abnormality detection circuit 160. The abnormality frequency counter is a value which indicates the number of times (the frequency) for which the control voltage Vm obtained by the abnormality detection circuit 160 is outside of a predetermined range.

In step S102, the abnormality detection circuit 160 obtains the control voltage Vm from the controller disposed on the drive control apparatus 120. The controller may be the position and speed following controller 150 exemplarily shown in FIG. 2 or the speed following controller 151 exemplarily shown in FIG. 4.

After obtaining the control voltage Vm, the abnormality detection circuit 160 determines whether the obtained control voltage Vm is outside of the predetermined range in step S103. For example, the predetermined range for comparing the control voltage Vm may be set previously based on a control voltage Vm when the motor 220 and the load function normally.

In a case in which the control voltage Vm is within the predetermined area (NO in step S103), the abnormality detection circuit 160 increments the obtain frequency counter by one (+1) in step S104. Subsequently, the abnormality detection circuit 160 determines whether the obtain frequency counter is equal to or larger than N in step S105. In the first embodiment, M may be an arbitrary value equal to or more than 2. N may be set previously.

In a case in which the obtain frequency counter is less than M (NO in step S105), the process subsequent to step S102 is executed. In a case in which the obtain frequency counter is equal to or larger than M (YES in step S105), it is judged that the motor 220 and the load drive normally. Then, the process subsequent to step S101 is executed again.

In a case in which the control voltage Vm outside of the predetermined area (YES in step S103), the abnormality detection circuit 160 increments the abnormality frequency counter by one (+1) in step S106. Subsequently, the abnormality detection circuit 160 determines whether the abnormality frequency counter is equal to or larger than N in step S107. In the first embodiment, N may be an arbitrary value equal to or more than 1 and be less than M. N may be set previously.

In a case which the abnormality frequency counter is less than N (NO in step S107), the process goes to step S104. At that time, although the control voltage Vm is outside of the predetermined range, it is judged that the abnormality does not occur in the motor 220 and the load because there is a possibility of a fluctuation of the load, a noise or the like.

In case which in which the abnormality frequency counter is equal to or more than N (YES in step S107), the abnormality detection circuit 160 sets an abnormality flag in step S108 and finishes the process. At that time, it is judged that some abnormality occurs in the motor 220 or the load. In other words, the abnormality detection circuit 160 stops obtaining the control voltage Vm (voltage instruction signal) in response to detecting the occurrence of the abnormality. As described above, in the case in which it is determined that the abnormality occurs, the first embodiment sets the abnormality flag and finishes the process. Thus, the abnormality determination does not need to be performed repeatedly during the same operation.

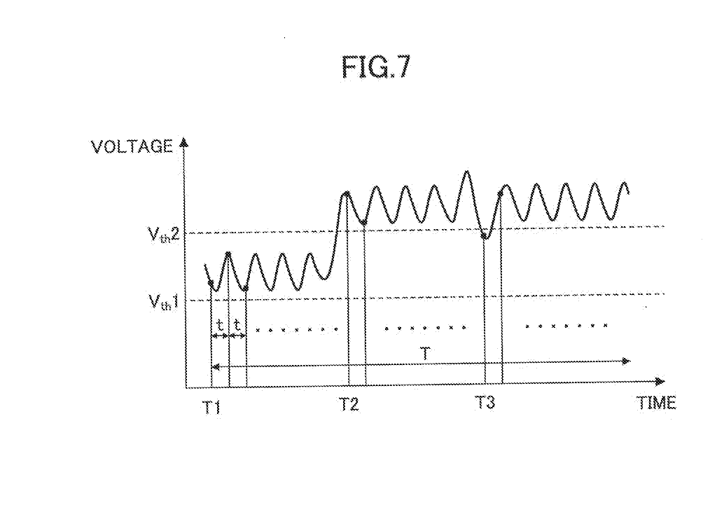

FIG. 7 is a graph for describing the abnormality detection process of the first embodiment. In the example graph shown in FIG. 7, the abscissa indicates an elapsed time and the ordinate indicates the voltage. Vth1 and Vth2 indicate the threshold of the predetermined range in which the control voltage Vm is compared in the abnormality detection process.

When the drive control apparatus 120 transmits the control signal to the motor driver 210 and the motor 220 starts rotating, the abnormality detection circuit 160 starts obtaining the control voltage Vm. For example, the abnormality detection circuit 160 obtains the control voltage Vm in a constant cycle t in order to obtain the control voltage Vm a predetermined number of times in a predetermined detection period T. In other words, the abnormality detection circuit 160 obtains the control voltage Vm a predetermined number of times at constant intervals. The cycle t, in which the abnormality detection circuit 160 obtains the control voltage Vm, may be set as an arbitrary value regardless a control cycle of the drive control apparatus 120.

It is preferable to set the cycle T, in which the abnormality detection circuit 160 obtains the control voltage Vm, equal to or longer than a cycle in which the position and speed following controller 150 generates the control signal. Thus, to obtain the same control voltage Vm repeatedly by the abnormality detection circuit 160 may be prevented, and a process load may be reduced. In other words, it is preferable that the interval of the abnormality detection circuit 160 obtaining the control voltage Vm (voltage instruction signal) is equal to or more than the interval at which the control voltage Vm (voltage instruction signal) is generated.

It is preferable to set the cycle T, in which the abnormality detect ion circuit 160 obtains the control voltage Vm, a natural number times as many as the cycle in which the position and speed following controller 150 generates the control signal. A microcomputer which controls both the position and speed following controller 150 and the abnormality detection circuit 160 may designed easily. In other words, it is preferable that the interval of the abnormality detection circuit 160 obtaining the control voltage Vm (voltage instruction signal) is a natural number times as many as the interval at which the position and speed following controller 150 generates the control voltage Vm (voltage instruction signal).

As shown in FIG. 7, only the obtain frequency counter is incremented while the control voltages vm, which are obtained by the abnormality detection circuit 160 after the time T1, are changing within the predetermined range (Vth1≦Vm≦Vth2). At that time, it is judged that the motor 220 and the load function normally.

For example, when the control voltage Vm which is obtained by the abnormality detection circuit 160 at the time T2 rises to exceed the threshold Vth2 due to the occurrence of some abnormality in the motor 220 or the load, both the obtain frequency counter and the abnormality frequency counter are incremented.

Similarly, when the control voltage Vm, which is obtained by the abnormality detection circuit 160, is decreased to become lower than the threshold Vth1 due to the occurrence of some abnormality in the motor 220 or the load, both the obtain frequency counter and the abnormality frequency counter are incremented.

The abnormality detection circuit 160 executes the above described process repeatedly, until the obtain frequency counter becomes equal to or larger than M and the detection period T elapses, or the abnormality frequency counter becomes equal to or larger than N. When the obtain frequency counter reaches N in a state that the abnormality frequency counter is less than N, the abnormality detection circuit 160 determines (judges) that the motor 220 and the load function normally. In this case, the abnormality detection circuit 160 executes the above described process repeatedly after clearing the obtain frequency counter and the abnormality frequency counter, until the obtain frequency counter becomes equal to or larger than M and the detection period T elapses again, or the abnormality frequency counter becomes equal to or larger than N.

In a case in which the abnormality frequency counter becomes equal to or larger than N before the obtain frequency counter reaches M, the abnormality detection circuit 160 determines (judges) that the abnormality occurs in the motor 220 or the load. Then, the abnormality detection circuit 160 sets the abnormality flag and finishes the process.

According to the abnormality detection process of the first embodiment, for example, as shown in FIG. 7, the abnormality of the motor 220 or the like may be detected even if the control voltage Vm becomes within the predetermined range momentarily (time T3) due to the fluctuation of the load, the noise or the like and the control voltage Vm does not become outside of the predetermined range continuously after the time T2. Thus, according to the abnormality detection process of the first embodiment, the abnormality of the motor 220 or the load may be detected more precisely.

### Second Embodiment

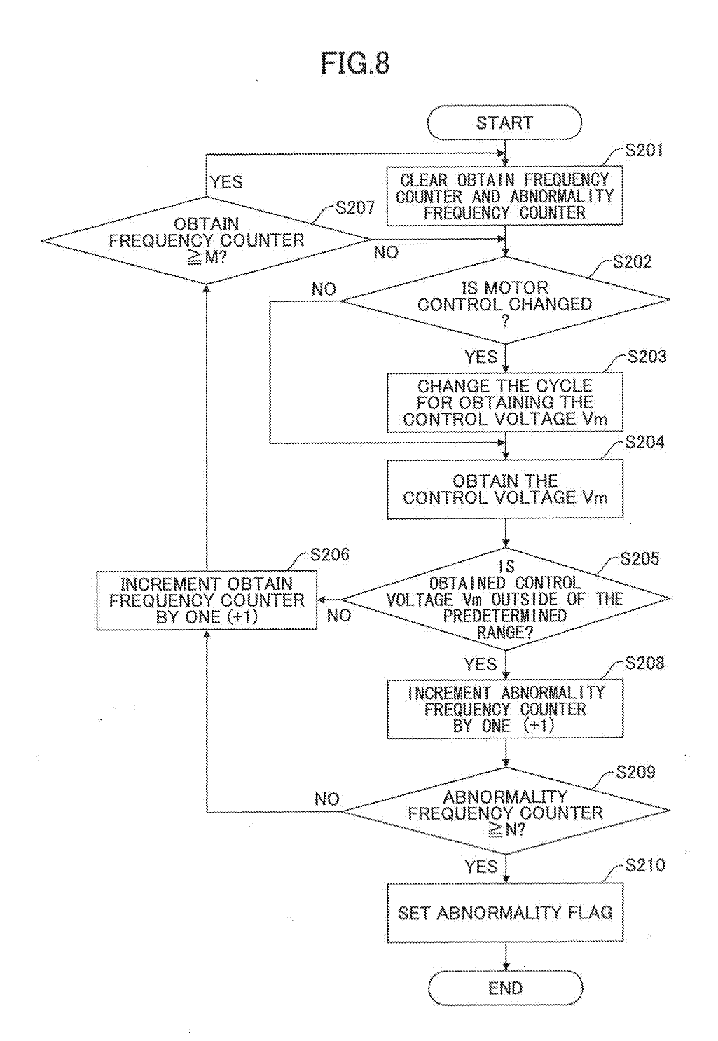

FIG. 8 is a flowchart for exemplarily illustrating a flow of the abnormality detection process of the second embodiment.

In step S201 of the abnormality detection process according to the second embodiment, the abnormality detection circuit 160 clears the obtain frequency counter and the abnormality frequency counter.

In step S202, the abnormality detection circuit 160 obtains, for example, the drive signal transmitted from the drive signal generating unit 110 or the target signal transmitted from the target position and target speed calculation circuit 130. Then, the abnormality detection circuit 160 determines whether a control of the drive speed or the like of the motor 220 is changed.

In a case in which the control of the motor 220 is changed (YES in step S202), the abnormality detection circuit 160 changes a cycle in which the control voltage Vm is obtained from the controller which is disposed on the drive control apparatus 120 in step S203.

For example, the abnormality detection circuit 160 changes the cycle, in which the control voltage Vm is obtained, based on the drive speed of the motor 220 or the output torque of the motor 220 which is varying in accordance with the drive speed. The abnormality detection circuit 160 has a table or a relational expression corresponding to the drive speed of the motor 220 and the output torque. The abnormality detection circuit 160 changes the cycle, in which the control voltage Vm is obtained, based on the table or the relational expression. In other words, the abnormality detection circuit 160 changes the interval of obtaining the control voltage vm (voltage instruction signal) based on a control, such as a driving speed, of the motor 220.

For example, in a case in which the drive speed of the motor 220 is decreased, the abnormality detection circuit 160 makes the cycle, in which the control voltage Vm is obtained, shorter. In a case in which the drive speed of the motor 220 is increased, the abnormality detection circuit 160 makes the cycle, in which the control voltage Vm is obtained, longer. As described above, to change the cycle, in which the control voltage Vm is obtained, enables to obtain the control voltage Vm every time the motor 220 rotates by same rotation amount (at the same rotational speed), and to maintain the precision of the abnormality detection regardless of the drive speed of the motor 220.

In a case in which the control of the motor 220 has not been changed (NO step S202), the abnormality detection circuit 160 does not change the cycle, in which the control voltage Vm is obtained, and the process goes to step S204

In step S204, the abnormality detection circuit 160 obtains the control voltage Vm from the controller in an obtaining cycle. The obtaining cycle may be the constant cycle or the cycle changed in step S203. Subsequently, the abnormality detection circuit 160 determines whether the obtained control voltage Vm is outside of the predetermined range in step S205.

In a case in which the control voltage Vm is within the predetermined area (NO in step S205), the abnormality detection circuit 160 increments the obtain frequency counter by one (+1) in step S206. Subsequently, the abnormality detection circuit 160 determines whether the obtain frequency counter equal to or larger than M in step S207. Similar to the first embodiment, M may be an arbitrary value equal to or more than 2. M may be set previously.

In a case in which the obtain frequency counter is less than M (NO in step S207), the process subsequent to step S202 is executed. In a case in which the obtain frequency counter equal to or larger than M (YES in step S207), it is judged that the motor 220 and the load drive normally. Then, the process subsequent to step S201 is executed again.

In a case in which the control voltage Vm is outside of the predetermined area (YES in step S205), the abnormality detection circuit 160 increments the abnormality frequency counter by one (+1) in step S208. Subsequently, the abnormality detection circuit 160 determines whether the abnormality frequency counter is equal to or larger than N in step S209. Similar to the first embodiment, N may be an arbitrary value equal to or more than 1 and be less than M. N may be set previously.

In a case in which the abnormality frequency counter is less than N (NO in step S209), the process goes to step S206. At that time, although the control voltage Vm is outside of the predetermined range, it judged that the abnormality does not occur in the motor 220 and the load because there is a possibility of a fluctuation of the load, a noise or the like.

In a case in which the abnormality frequency counter is equal to or more than N (YES in step S209), the abnormality detection circuit 160 sets the abnormality flag in step S210 and finishes the process. At that time, it is judged that some abnormality has occurred in the motor 220 or the load. In other words, the abnormality detection circuit 160 detects the occurrence of the abnormality in response to detecting that the control voltage Vm (voltage instruction signal) is outside of the predetermined range N times in the detection time period T.

According to the abnormality detection process of the second embodiment, the abnormality of the motor 220 or the load may be detected precisely by changing the cycle, in which the control voltage Vm is obtained, even if the control of the motor 220 is changed and to change the drive speed.

### Third Embodiment

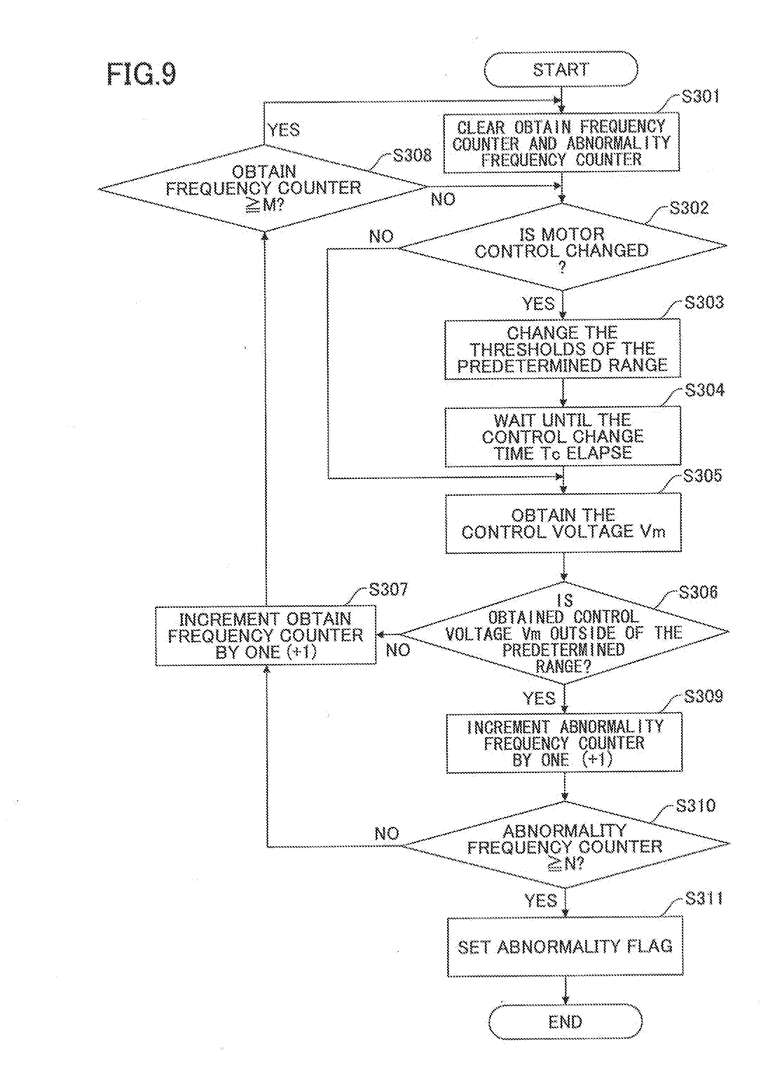

FIG. 9 is a flowchart for exemplarily illustrating a flow of the abnormality detection process of the third embodiment.

In step S301 of the abnormality detection process according to the third embodiment, the abnormality detection circuit 160 clears the obtain frequency counter and the abnormality frequency counter.

In step S302, the abnormality detection circuit 160 obtains, for example, the drive signal transmitted from the drive signal generating unit 110 or the target signal transmitted from the target position and target speed calculation circuit 130. The abnormality detection circuit 160 determines whether the control of the drive speed of the motor 220 or the like is changed.

In a case in which the control of the motor 220 is changed (YES in step S302), the abnormality detection circuit 160 changes a threshold of the predetermined range for comparing the control voltage Vm in step S303.

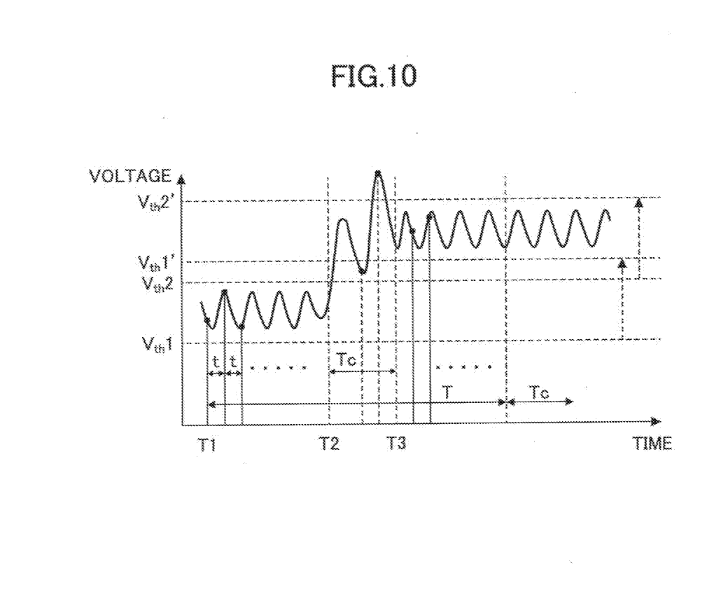

FIG. 10 is a diagram for describing the abnormality detection process of the third embodiment. FIG. 10 exemplarily shows a control voltage in a case in which the drive speed of the motor 220 is changed at the time T2.

As shown in FIG. 10, for example, the control voltage of the motor 220 rises or falls when the control of the motor 220 is changed. Thus, if the abnormality detection circuit 160 executes the abnormality detection based on the thresholds Vth1 and Vth2 which are the thresholds before the control is changed, the abnormality detection circuit 160 determines (judges) that the abnormality occurs the motor 220 or the load in error even though the motor 220 and the load function normally.

Thus, for example, the abnormality detection circuit 160 may increase each of the thresholds from the Vth1 and Vth2 to the Vth1′ and Vth2′ respectively, in a case in which the control of the motor 220 is changed and the control voltage is increased. As described above, to change the predetermined range (from Vth1 to Vth1′ and from Vth2 to Vth2′), which is used for the abnormality detection, may prevent the error of the abnormality detection.

Both the thresholds Vth1 and Vth2 may be changed to larger values in accordance with a changed content of the control of the motor 220. Both the thresholds Vth1 and Vth2 may be changed to smaller values in accordance with the changed content of the control of the motor 220. Further, one of the thresholds Vth1 and Vth2 may be changed to a larger value and the other of the thresholds Vth1 and Vth2 may be changed to a smaller value in order to enlarge or reduce the predetermined range. The larger value may larger than the value before the control is changed. The smaller value may smaller than the value before the control is changed.

As exemplarily shown in FIG. 10, after the control of the motor 220 is changed at the time T2, the control voltage may fluctuate largely and become equal to or less than the threshold Vth1′ or equal to or more than the threshold Vth2′. As a result, the precision of the abnormality detection may decrease. Thus, the abnormality detection circuit 160 stops obtaining the control voltage Vm in a control change period Tc, which is a period from the time T2 to the time T3, in the case in which the control of the motor 220 is changed. In other words, the abnormality detection circuit 160 refrains from obtaining the control voltage Vm (voltage instruction signal) during the control change period Tc after the control of the drive unit is changed.

The above described changing of the predetermined range and the above described setting of the control change period Tc may be performed in accordance with the changed content of the control of the motor 220, for example, based on the table or the like contained in the abnormality detection circuit 160.

As described above, in the case in which the control of the motor 220 is changed, the abnormality detection circuit 160 changes the thresholds Vth1 and Vth2 of the predetermined range which is used for the abnormality detection. Further, the abnormality detection circuit 160 stops obtaining the control voltage Vm until the control change period Tc elapses. Thus, the abnormality detection may be performed precisely.

In the flowchart exemplarily shown in FIG. 9, step S304, the abnormality detection circuit 160 stops obtaining the control voltage Vm until the control change period Tc elapses as described above, and waits.

In a case in which the control of the motor 220 has not been changed (NO step S302), the abnormality detection circuit 160 does not change the predetermined range (thresholds Vth1 and Vth2), which used for the abnormality detection, and the process goes to step S305.

In step S305, the abnormality detection circuit 160 obtains the control voltage Vm from the controller. Subsequently, the abnormality detection circuit 160 determines whether the obtained control voltage Vm is outside of the set predetermined range (thresholds Vth1 and Vth2) the changed predetermined range (thresholds Vth1′ and Vth2′) in step S306.

In a case in which the control voltage Vm is within the predetermined area (NO in step S306), the abnormality detection circuit 160 increments the obtain frequency counter by one (+1) in step S307. Subsequently, the abnormality detection circuit 160 determines whether the obtain frequency counter equal to or larger than M in step S308. Similar to the first and second embodiments, M may be an arbitrary value equal to or more than 2. M may be set previously.

In a case in which the obtain frequency counter is less than M (NO in step S308), the process subsequent to step S302 is executed. In a case in which the obtain frequency counter equal to or larger than M (YES in step S308), it is judged that the motor 220 and the load drive normally. Then, the process subsequent to step S301 is executed again. In a case in which the control or the motor 220 has been changed, the abnormality detection circuit 160 stops obtaining the control voltage Vm in the control change period Tc, and waits in step S304. Thus, the detection period T is extended by the control change period Tc.

In a case in which the control voltage Vm is outside of the predetermined area (YES in step S306), the abnormality detection circuit 160 increments the abnormality frequency counter by one (+1) in step S309. Subsequently, the abnormality detection circuit 160 determines whether the abnormality frequency counter is equal to or larger than N in step S310. Similar to the first and second embodiments, N may be an arbitrary value equal to or more than 1 and be less than M. N may be set previously.

In a case which the abnormality frequency counter is less than N (NO in step S310), the process goes to step S307. At that time, although the control voltage Vm is outside of the predetermined range, it is judged that the abnormality does not occur in the motor 220 and the load because there is a possibility of a fluctuation of the load, a noise or the like.

In a case in which the abnormality frequency counter is equal to or more than N (YES in step S310), the abnormality detection circuit 160 sets the abnormality flag in step S311 and finishes the process. At that time, it is judged that some abnormality has occurred in the motor 220 or the load.

According to the abnormality detection process of the third embodiment, the abnormality of the motor 220 or the load may be detected precisely even if the control of the motor 220 is changed, by changing the thresholds Vth1 and Vth2 of the predetermined range for comparing the control voltage Vm and stopping obtaining the control voltage Vm in the control change period Tc.

In the abnormality detection process of the third embodiment, similar to the second embodiment, the cycle in which the abnormality detection circuit 160 obtains the control voltage Vm may be changed in toe case in which the control of the motor 220 is changed.

### Fourth Embodiment

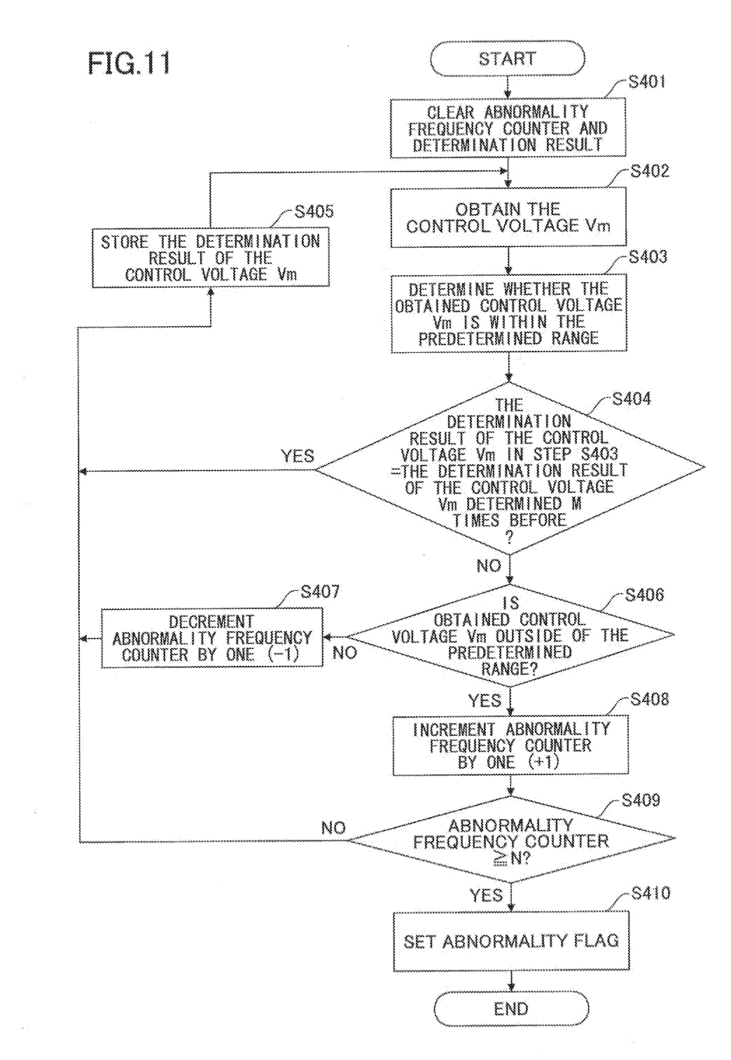

FIG. 11 a flowchart for exemplarily illustrating a flow of the abnormality detection process of the fourth embodiment.

In step S401 of the abnormality detection process according to the fourth embodiment, the abnormality detection circuit 160 clears the abnormality frequency counter and a determination result stored in the memory unit 161. In step S402, the abnormality detection circuit 160 obtains the control voltage Vm from the controller. For example, the abnormality detection circuit 160 obtains the control voltage Vm from the controller in the predetermined cycle (at the constant cycle t) in order to obtain the control voltage Vm equal to or more (greater) than M times in the detection period T, which is set. Similar to the first to third embodiments, M may be an arbitrary value equal to or more than 2. M may be set previously.

In step S403, the abnormality detection circuit 160 determines whether the obtained control voltage Vm is within the predetermined range. Subsequently, the abnormality detection circuit 160 determines whether the determination result in step S403 and a determination result determined M times before and stored in the memory unit 161 are the same determination result in step S404.

For example, in a case in which the abnormality detection circuit 160 determines that the control voltage Vm is within the predetermined range in step S403 and the abnormality detection circuit 160 determined M times before that the control voltage Vm is within the predetermined range, the detection results are the same (YES in step S404) and the process goes to step S405. Similarly, in a case in which the abnormality detection circuit 160 determines that the control voltage Vm is outside of the predetermined range in step S403 and the abnormality detection circuit 160 determined M times before that the control voltage Vm is outside of the predetermined range, the detection results are the same (YES in step S404) and the process goes to step S405.

The determination result of the abnormality detection circuit 160 in Step S403 is stored in the memory unit 161 in step S405. Then, the process subsequent to step S402 is executed.

For example, in a case in which the abnormality detection circuit 160 determines that the control voltage Vm is within the predetermined range in step S403 and the abnormality detection circuit 160 determined M times before that the control voltage Vm is outside of the predetermined range, the process goes to step S406 because the detection results are different (NO in step S404). Similarly, in a case in which the abnormality detection circuit 160 determines that the control voltage Vm is outside of the predetermined range in step S403 and the abnormality detection circuit 160 determined M times before that the control voltage Vm is within the predetermined range, the process goes to step S406 because the detection results are different (NO in step S404). Further, in a case in which the detection results are not stored in the memory unit 161 for M times, the process goes to step S406 as the detection results being different (NO in step S404).

In step S406, the abnormality detection circuit 160 determines whether the control voltage Vm obtained in step S402 is outside of the predetermined range. In a case in which the control voltage Vm is within the predetermined area (NO in step S406), the abnormality detection circuit 160 decrements the abnormality frequency counter by one (−1) in step S407 and the process goes to step S405. However, in the case in which the detection results are not stored in the memory unit 161 for M times, the process goes to step S405 without decrementing the abnormality frequency counter.

In a case in which the control voltage Vm is outside of the predetermined area (YES in step S406), the abnormality detection circuit 160 increments the abnormality frequency counter by one (+1) in step S408. Subsequently, the abnormality detection circuit 160 determines whether the abnormality frequency counter is equal to or larger than N in step S409. Similar to the first to third embodiments, N may be an arbitrary value equal to or more than 1 and be less than M. N may be set previously.

In a case in which the abnormality frequency counter is less than N (NO in step S409), the process goes to step S405. At that time, although the control voltage Vm is outside of the predetermined range, it is judged that the abnormality does not occur in the motor 220 and the load because there is a possibility of a fluctuation of the load, a noise or the like.

In a case in which the abnormality frequency counter is equal to or more than N (YES step S409), the abnormality detection circuit 160 sets the abnormality flag in step S410 and finishes the process. At that time, it is judged that some abnormality occurs in the motor 220 or the load.

The above described abnormality detection process may a process which detects the abnormality of the motor 220 or the load every time the abnormality detection circuit 160 obtains the control voltage Vm in the predetermined cycle based on the control voltage Vm stored in the memory unit 161 in the last detection time period T. That is the above described abnormality detection process may be a process which determines whether the control voltage stored in the memory unit 161 in the last detection period T is within the predetermined range. The process may detect the abnormality of the motor 220 or the load in a case in which the control voltage becomes (goes) outside of the predetermined range for N times or more.

The abnormality detection process according to the fourth embodiment may enable to execute the abnormality detection in the cycle in which the control voltage Vm is obtained. Thus, the interval of the abnormality detection becomes shorter, and the abnormality of the motor 220 or the load may be detected precisely and sensitively.

In the abnormality detection process of the fourth embodiment, similar to the second embodiment, the cycle in which the abnormality detection circuit 160 obtains the control voltage Vm may be changed in the case in which the control of the motor 220 is changed. Similar to the third embodiment, the fourth embodiment may change the thresholds Vth1 and Vth2 of the predetermined range for comparing the control voltage Vm and stop obtaining the control voltage Vm in the control change period Tc. Thus, the abnormality of the motor 220 or the load may be detected more precisely.

### Fifth Embodiment

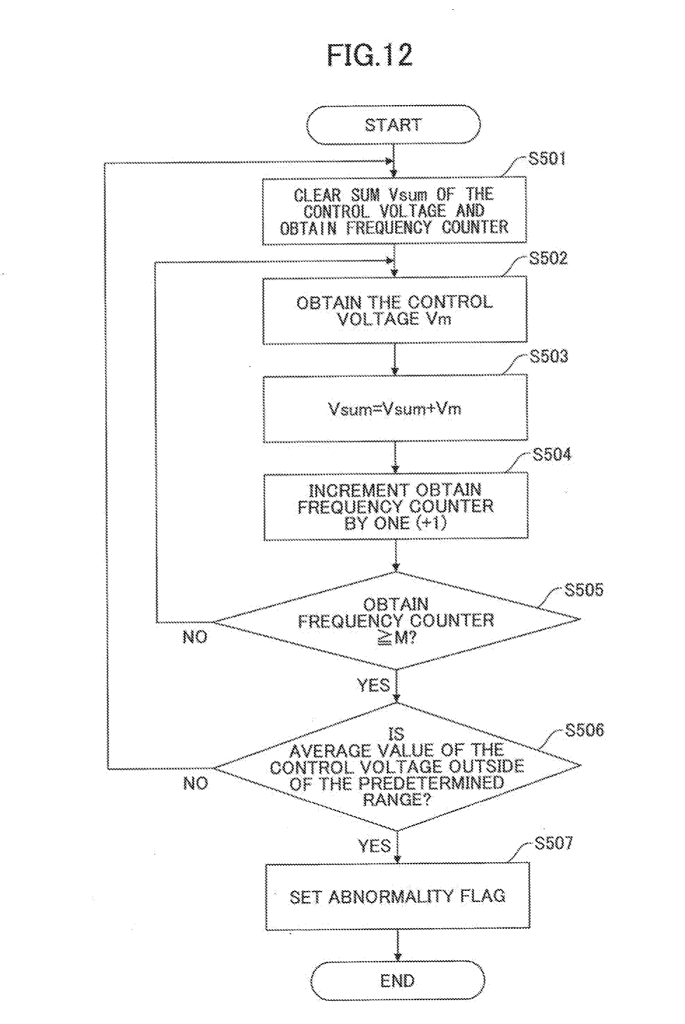

FIG. 12 is a flowchart for exemplarily illustrating a flow of the abnormality detection process of the fifth embodiment.

In step S501 of the abnormality detection process according to the fifth embodiment, the abnormality detection circuit 160 clears a sum Vsum of the control voltage and the obtain frequency counter. The sum Vsum of the control voltage is an integrated value of the control voltages Vm obtained by the abnormality detection circuit 160.

In step S502, the abnormality detection circuit 160 obtains the control voltage Vm from the controller disposed on the drive control apparatus 120. For example, the abnormality detection circuit 160 obtains the control voltage Vm from the controller in the predetermined cycle in order to obtain the control voltage Vm equal to or more than M times in the detection period T which is set. Similar to the first to fourth embodiments, M may be an arbitrary value equal to or more than 2. M may be set previously.

In step S503, the abnormality detection circuit 160 adds the obtained control voltage Vm to the sum Vsum of the control voltage. In step S504, the abnormality detection circuit 160 increments the obtain frequency counter by one (+1). In step S505, the abnormality detection circuit 160 determines whether the obtain frequency counter is equal to or larger than M.

In a case in which the obtain frequency counter is less than N (NO in step S505), the process subsequent to step S502 is executed. In a case in which the obtain frequency counter equal to or larger than M (YES in step S505), the process goes to step S506.

In step S506, the abnormality detection circuit 160 determines whether the average value of the control voltage (Vsum/N) is outside of the predetermined range. The range of the voltage value for comparing the average value of the control voltage may be set previously based on the control voltage Vm when the motor 220 and the load function normally.

In a case in which the average value of the control voltage is within the predetermined area (NO in step S506), the process subsequent to step S501 is executed repeatedly. At that time, it is judged that the motor 220 and the load function normally.

In a case in which the average value of the control voltage is outside of the predetermined area (YES in step S506), there is a possibility that the abnormality occurs in the motor 220 or the load this case, the abnormality detection circuit 160 sets the abnormality flag in step S507 and finishes the process other words, the abnormality detection circuit 160 detects the occurrence of the abnormality in response to detecting that the average control voltage (voltage instruction signal) in the detection time period T is outside of the predetermined range.

According to the abnormality detection process of the fifth embodiment, similar to the first embodiment, the abnormality of the motor 220 or the like may be detected even if the control voltage Vm becomes within the predetermined range momentarily due to the fluctuation of the load, the noise or the like and the control voltage Vm does not become outside of the predetermined range continuously. Further, to detect the abnormality based on the average of the control voltage may reduce the influence of the fluctuation of the load, the noise or the like. Thus, the abnormality of the motor 220 or the load may be detected precisely.

In the abnormality detection process of the fifth embodiment, similar to the second embodiment, the cycle in which the abnormality detection circuit 160 obtains the control voltage Vm may be changed in the case in which the control of the motor 220 is changed. Similar to the third embodiment, the fifth embodiment may change the thresholds Vth1 and Vth2 of the predetermined range for comparing the control voltage Vm and stop obtaining the control voltage Vm in the control change period Tc. Thus, the abnormality of the motor 220 or the load may be detected more precisely.

Further, the abnormality detection circuit 160 may store the control voltage Vm in the memory unit 161 every time the control voltage Vm is obtained, and detect the abnormality of the motor 220 or the load based on the control voltage Vm stored in the memory unit 161 in the last detection time period T. The above described process may enable to execute the abnormality detection in the cycle in which the control voltage Vm is obtained. Thus, the interval of abnormality detection becomes shorter, and the abnormality of the motor 220 or the load may be detected precisely and sensitively.

As described above, the drive control apparatus 120 according to the embodiments may detect the abnormality of the motor 220 or the load precisely by executing the above described abnormality detection process.

Further, the image forming apparatus 100 which includes the drive control apparatus 120 may detect the abnormality of the motor 220 and the load, and prevent the failure or the like of these configuration elements. The load may be the developing roller, the transfer roller, or the like which are connected to the motor. Similarly, a conveying apparatus which includes the drive control apparatus 120 and the conveying roller 28 connected to the motor 220 may detect the abnormality of the motor 220 or the conveying roller 28 precisely. For example, the conveying apparatus may monitor conveyance state of the recording material or the like.

In the case in which the abnormality detection circuit 160 detects the abnormality of the motor 220 or the load, the detection result may be stored in the detection result memory unit 170 and, the displaying unit 230 may display the determination result. Further, in the case in which the abnormality detection circuit 160 detects the abnormality of the motor 220 or the load, the abnormality detection circuit 160 may control the target position and target speed calculation circuit 130, the position and speed following controller 150 and the like order to stop the motor 220. Further, the abnormality detection circuit 160 may transmit the determination result to the drive signal generating unit 110 and stop the image forming apparatus 100 or the entire system of the conveyance apparatus.

As described above, to stop the motor 220 or the entire system in the case which the abnormality of the motor 220 or the loads detected may enable to minimize the damage of the motor 220, the load or other configuration elements.

Although the drive control apparatus, the conveyance apparatus, the image forming apparatus, and the drive control method are described above, the present invention is not limited to these embodiments, but various variations and modifications may be made without departing from the scope of the present invention.

For example, although the above described image forming apparatus performs printing by the electrophotographic system, the image forming apparatus may perform printing by an ink jet system or another system. Further, the drive control apparatus may be disposed on an apparatus which may rotate the load by the motor other than the image forming apparatus.

The present application is based on and claims benefit of priority of Japanese Priority Application No. 2015-009276 filed on Jan. 21, 2015, with the Japanese Patent Office, the entire contents of which are hereby incorporated by reference.

What is claimed is:

1. A drive control apparatus comprising:
a controller configured to control a drive unit based on a voltage instruction signal obtained from a target signal; and
an abnormality detection unit configured to obtain the voltage instruction signal M times in a detection time period, the abnormality detection unit detecting occurrence an abnormality in response to detecting that the voltage instruction signal is outside predetermined range N times in the detection time period, where M is equal to or more than 2 and N is equal to or more than 1 and N is less than M.

2. A drive control apparatus comprising:
a controller configured to control a drive unit based on a voltage instruction obtained from a target signal; and
an abnormality detection unit configured to obtain the voltage instruction signal a plurality of times in a detection time period, the abnormality detection unit detecting occurrence of an abnormality response to detecting that an average the voltage instruction signals is outside of a predetermined range in the detection time period.

3. The drive control apparatus as claimed in claim 1, wherein the abnormality detection unit is configured to obtain the voltage instruction signal M times at constant intervals.

4. The drive control apparatus as claimed in claim 3, wherein the abnormality detection unit is configured to change the interval of obtaining the voltage instruction signal based on a driving speed of the drive unit.

5. The drive control apparatus as claimed in claim 3, wherein the interval of the abnormality detection unit obtaining the voltage instruction signal is equal to or more than an interval at which n controller generates the voltage instruction.

6. The drive control apparatus as claimed in claim 3, wherein the interval of the abnormality detection obtaining the voltage instruction signal is a natural number times an interval at which the controller generates the voltage instruction signal.

7. The drive control apparatus as claimed in claim 1, wherein the abnormality detection unit includes a memory unit configured to store the voltage instruction signal which is obtained from the controller, and
wherein the abnormality detection unit is configured to detect the abnormality based on the voltage instruction signal stored in the memory unit in the last detection time period every time the controller obtains the voltage instruction signal from the controller.

8. The drive control apparatus as claimed in claim 1, wherein the abnormality detection unit is configured to refrain from obtaining the voltage instruction signal during a control change period after a control of the drive unit is changed.

9. The drive control apparatus as claimed in claim 1, wherein the abnormality detection unit is configured to change the predetermined range based on a driving speed of the drive unit.

10. The drive control apparatus as claimed in claim 1, further comprising:
a detection result memory unit configured to store a detection result of the abnormality detection unit.

11. The drive control apparatus as claimed in claim 1, wherein the abnormality detection unit is configured to stop obtaining the voltage instruction signal in response to detecting the occurrence of the abnormality.

12. The drive control apparatus as claimed in claim 1, wherein the abnormality detection unit is configured to stop driving of the drive unit in response to detecting the occurrence of the abnormality.

13. The drive control apparatus as claimed in claim 1, further comprising:
a displaying unit configured to display a detection result of the abnormality detection unit.

14. A conveying apparatus comprising drive control apparatus as claimed in claim 1.

15. A conveying apparatus comprising drive control apparatus as claimed in claim 2.

16. The conveying apparatus as claimed in claim 14, further comprising:
a system stop unit configured to stop an entire system response to an event that the abnormality detection unit detects the occurrence of the abnormality.

17. An image forming apparatus comprising the drive control apparatus as claimed in claim 1.

18. An image forming apparatus comprising the drive control apparatus as claimed in claim 2.

19. The image forming apparatus as claimed in claim 17, further comprising:
a system stop unit configured to stop an entire system in response to an event that the abnormality detection unit detects the occurrence of the abnormality.

20. A drive control method comprising:
con trolling a drive unit based on a voltage instruction signal obtained from a target signal; and
obtaining the voltage instruction signal M times in a detection time period and detecting occurrence of an abnormality in response to detecting that the voltage instruction signal is outside of a predetermined range N times in the detection time period, where M is equal to or more than 2 and N is equal to or more than 1 and N is less than M.
